(19) United States
(12) Patent Application Publication
(10) Pub. No.: US 2010/0279610 A1
(43) Pub. Date: Nov. 4, 2010

(54) SYSTEM FOR RECEIVING AND TRANSMITTING ENCRYPTED DATA

(76) Inventors: Anders Bjorhn, Lidingo (SE); Emil-Emir Pilavic, Helsingborg (SE); Adrian Hinz, Stockholm-Spanga (SE)

Correspondence Address: Manelii Denison & Selter PLLC, 2000 M Street, 7th Floor, Washington DC, DC, 20036, US

(21) Appl. No.: 12/746,538

(22) PCT Filed: Dec. 19, 2008
(86) PCT No.: PCT/SE2008/000730

§ 371 Date: Jun. 22, 2010

(30) Foreign Application Priority Data
Dec. 19, 2007 (SE) 0702829-3
Dec. 26, 2007 (US) 12006293
Apr. 8, 2008 (SE) 0800784-1
Apr. 10, 2008 (US) 12081108

(51) Int. Cl. H04B 7/00; H04Q 5/22

(52) U.S. Cl. 455/41.2; 340/10.42; 455/550.1

(57) ABSTRACT

The invention regards a system where only one first device has a radio frequency identification tag that is recognized by payment software and vice versa. Hence, it is preventing that the payment software is utilized as a clone in other first devices. The first device can be a cellular phone (10), and the second device (32) a payment module for purchase through a point of sale, POS.

### TECHNICAL FIELD

The present invention pertains to a system comprising a first radio operated device, and at least one second radio operated device adapted to at least one of receiving and transmitting encrypted data between each other, and a method therefore.

### BACKGROUND ART

There is a need for a substitution to a credit card and the like. Currently it is common that a person carries multiple such cards in for instance a wallet. Ten to twenty cards are not unusual. Moreover, a huge number of people in all societies are owners to cellular phones, which they most likely carry everywhere they go and travel. Hence, it would be favorable only carrying a single device, which is well guarded by most persons, necessary in every day business, and thus seldom forgotten when leaving home.

Furthermore, there is a need for a safe encryption protocol to transfer data between radio devices having cellular phone capabilities, which also includes a PDA (Personal Digital Assistant) operating in any cellular network or the like such as GSM (Global System for Mobile communication) utilizing TDMA (Time Division Multiple Access), CDMA (Code Division Multiple Access), WCDMA (Wideband Code Division Multiple Access, FDMA (Frequency Division Multiple Access), GSM/3G (third generation) or any other in the market appropriate mobile or cellular system.

Such an encryption protocol should also be useful when transmitting through Bluetooth, RFID (Radio Frequency Identification) from a cellular phone/PDA too devices other then cellular phones/PDA having Bluetooth, RFID receivers and/or transmitters.

### SUMMARY OF THE INVENTION

An aim of the present invention is to provide a new and inventive encryption protocol/scheme comprised in a cellular phone, to transfer data, including speech when proper, in order to accomplish a safe transmission from and to cellular phones, or between cellular phones and other devices having receivers and/or transmitters to communicate through Bluetooth and/or RFID. Also, the present invention encryption can be utilized for radio communication between other devices then cellular phones, having such capabilities.

Moreover, the present invention provides an inventive manner to avoid cloning of software utilized by a cellular phone to perform the tasks of the present invention with regard to RFID communication between the cellular phone and a device named a puck or pay module as described below.

Furthermore, the present invention provides a device, a puck or pay module, to be connected/embedded to/in POS equipment for purchases.

The present invention provides that no modification to existing POS terminals is normally necessary, if the POS has interfaces adapted to receive communication through USB, Rs232, and Rs485 ports, or other similar known communication ports.

A device with cellular phone capabilities is provided the encryption protocol/scheme in accordance with the present invention, as well as the device of the present invention. But, the encryption of the present invention can be provided only to the cellular phone, when utilized for other radio communication then purchasing at a POS.

The present invention provides a plurality of application embodiments utilizing its encryption protocol/scheme for safer communication of information and data. One inventive application presents a substitution to cards used for payment such as credit cards, shop cards, debit cards, smart cards, petrol cards, bank cards, custom relations management cards, and the like. Henceforth, all cards are comprised as bank cards for the simplicity of the description, but not limiting the present invention to one type of card.

One application of the present invention comprises that a cellular telephone number is a unique identifier of the person bearing the phone.

Another application of the present invention provides that a cellular phone comprises a barcode generator generating barcodes in the phone display with the use of encryption keys provided to a database comprising the same barcode generator and encryption key in a data post bearing the phone number of the cellular phone mentioned. Hence, the same barcode is generated in booth the cellular phone and the database at any predetermined given time period for matching when purchasing at a POS (Point Of Sale) through the barcode presented in the cellular phone display, thus preventing forgery by for example taking a footage of the barcode presented in the display together with the specific phone number for the phone, also stored in the database for matching. In one embodiment the phone number is always present within the barcode, but the barcode is differently generated for every purchase by the utilization of a key as mentioned.

An alternative embodiment comprises that the device of the present invention comprises a bar code generator providing a cellular phone with new barcodes after a purchase has been accomplished through the barcode displayed in the phone display screen.

Moreover, a cellular phone according to the present invention is equipped with an RFID tag/chip, providing active or passive communication. As is known to a person skilled in the present art, current devices with cellular phone transmission capabilities are equipped with IR and/or Bluetooth communication to transmit and receive data. Hence, it is appreciated that the encryption protocol/scheme is downloaded to the cellular device according to the present invention and stored in one of the devices available memories.

To accomplish what is mentioned and other advantages, the present invention sets forth a system comprising a first radio operated device, and at least one second radio operated device adapted to at least one of receiving and transmitting encrypted data between each other by establishing a data connection. The inventive system comprises:

radio frequency identification (RFID) means;

blue tooth capacity;

the first device having payment software comprising a unique identification;

the first device radio frequency identification having a unique identification attached to it;

the first device unique identifications being transmitted to the second device and matched in the second device to detect if they are valid for the first device;

only one first device having an radio frequency identification tag that is recognized by the payment software and vice versa;

thus preventing the payment software being utilized as a clone in other first devices;

the first and at least second device comprise:

an encryption algorithm in a memory;

a key exchange protocol to provide a final key which activates the encryption algorithm in the devices;

a random multiple integer start value generator, continuously incrementing the integer in a loop for such a purpose;

the continuously incremented integer being a random start value received by the key exchange protocol at the moment of a transmission being established by one of the devices, utilized by the key exchange as a first key;

a changeable device user second key, input by the user to the key exchange protocol;

a third key is hard coded and provided the key exchange protocol;

the key exchange protocol utilizing the first, second and third key to create the final key to start the encryption algorithm;

after agreement through hand shaking of the final key, provided by the key exchange protocol, by the first and second devices through a radio communication, the encryption algorithm starts encrypting an established transmission of data between the first and at least one second device;

transmitted data is packet as a header of a predetermined number of bytes plus encrypted data of a predetermined number of bytes, the header being utilized to synchronize transmission of data if bytes in a communication between devices are lost or added; and

to minimize delay time between devices participating in a transmission of data incoming data traffic is searched for the latest header, and earlier received data is discarded, whereby the encrypted data always comprises the latest complete incoming header plus data, which is stored in a buffer of a predetermined size.

In one embodiment of the present invention an established transmission is released if the text CARRIER is a part of incoming data, or when a button for releasing transmission is pushed on the first or second devices.

Another embodiment comprises that the first device has cellular phone capacity and the at least one second device has cellular phone capacity.

A further embodiment provides that the first device has cellular phone capacity, and the second device is an entity connected/comprised to/in a POS terminal, whereby a purchase is accomplished through the phone and the entity, utilizing RFID or Bluetooth transmission.

Another embodiment comprises that the communication between the first and second device is initially established through Bluetooth, and later by RFID.

Yet another embodiment comprises that encryption/encoding software is bound/affiliated to a cellular phones international mobile station equipment identity.

### BRIEF DESCRIPTION OF THE DRAWINGS

Henceforth reference is had to the attached figures in the accompanying text of the description for a better understanding of the present invention with its embodiments and given examples, wherein:

FIG. 1 schematically illustrates one embodiment of a cellular phone in accordance with the present invention;

FIG. 2 schematically illustrates one embodiment of a bank card;

FIG. 3 schematically illustrates an embodiment of a system for a point of sale in accordance with the present invention;

FIG. 4 schematically illustrates a block diagram of a device connected to a POS depicted in FIG. 3 and FIG. 5 in accordance with the present invention;

FIG. 5 schematically illustrates a block diagram depicting the device of FIG. 4 generating bar codes to be displayed in a cellular phone display screen:

FIG. 6 schematically illustrating a system according to FIG. 3, wherein a cellular phone and a database comprising the same unit/program generating barcodes or 2D codes or like codes on the market;

FIG. 7 schematically illustrates an embodiment of internal payment software and a RFID tag in a cellular phone in accordance with the present invention;

FIG. 8 to FIG. 10 schematically illustrate an embodiment in accordance with FIG. 7 utilizing blue tooth and RFID communication to permit a purchase; and

FIG. 11 schematically illustrates an embodiment of how goods are purchased over Internet, and a gate passing embodiment in accordance with the present invention.

### DETAILED DESCRIPTION OF PREFERRED EMBODIMENTS

An aim of the present intention is to provide a new and inventive encryption protocol/scheme comprised in a cellular phone, to transfer data, including speech when proper, in order to accomplish a safe transmission from and to cellular phones, or between cellular phones and other devices having receivers and/or transmitters to communicate through Bluetooth and/or RFID. Also, the present invention encryption can be utilized for radio communication between other devices then cellular phones, having such capabilities.

Furthermore, the present invention provides a device to be connected/embedded in POS equipment for purchases.

A device with cellular phone capabilities is provided the encryption protocol/scheme in accordance with the present invention, as well as the device/puck/pay module of the present invention. But, the encryption of the present invention can be provided solely to the cellular phone, when utilized for other radio communication then purchasing at a POS.

In fact, when the device/puck/pay module is comprised in a cellular phone, the phone is able to act as a POS terminal. It can also act as a money transfer between cellular phones.

The present invention provides a plurality of application embodiments utilizing its encryption protocol/scheme for safer communication of information and data. One inventive application presents a substitution to cards used for payment such as credit cards, shop cards, debit cards, smart cards, petrol cards, bank cards, custom relations management cards, and the like. Henceforth, all cards are comprised as bank cards for the simplicity of the description, but not limiting the present invention to one type of card.

One application of the present invention comprises that a cellular telephone number is a unique identifier of the person bearing the phone.

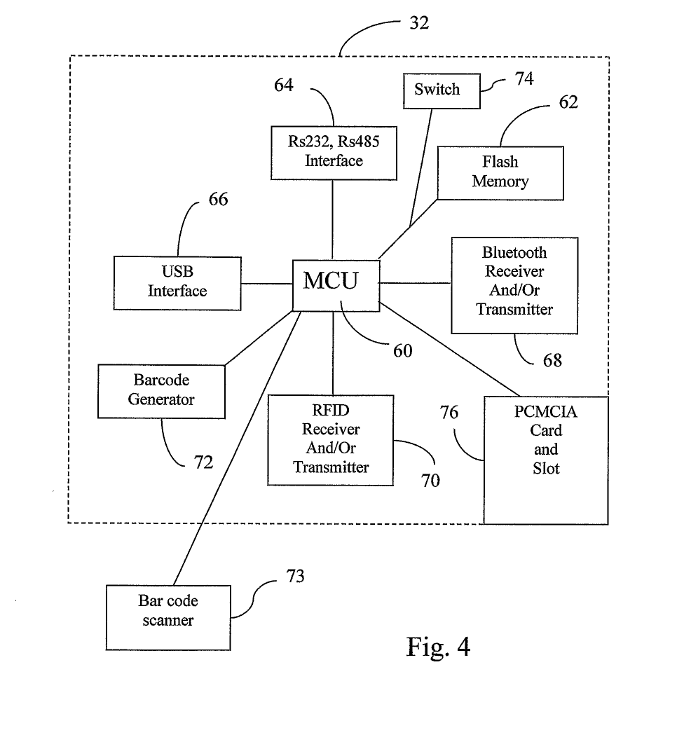

Another application of the present invention provides that a cellular phone comprises a barcode generator generating barcodes in the phone display with the use of encryption keys provided to a database comprising the same barcode generator and encryption key in a data post bearing the phone number of the cellular phone mentioned. Hence, the same barcode is generated in booth the cellular phone and the database at any predetermined given time period for matching when purchasing at a POS (Point Of Sale) through the barcode presented in the cellular phone display, thus preventing forgery by for example taking a footage of the barcode presented in the display together with the specific phone number for the phone, also stored in the database for matching. In one embodiment the phone number is always present within the barcode, but the barcode is differently generated for every purchase by the utilization of a key as mentioned. The POS terminal utilizes for instance the commonly utilized PCI-DSS standard (Payment Card Industry Data Security Standard) for transactions such as payment. Hence, the device/puck/pay module does not interfere with the PCI-DSS standard when transaction are accomplished through the POS communication protocol, i.e., no changes or updating of the POS is necessary. The pay module is described through FIG. 4 and its related text.

An alternative embodiment comprises that the device/puck/pay module of the present invention comprises a bar code generator providing a cellular phone with new barcodes after a purchase has been accomplished through the barcode displayed in the phone display screen. Another embodiment comprises that the device/puck/pay module is provided radio transmitting and receiving equipment such as a cellular phone or the like, whereby it can act as a POS on its own. If the radio equipment is not embedded in the module it can be provided through a PCMCIA card (Personal Computer Memory Card Association) through a slot added to the module for this purpose, or through an USB device equipped with radio communication capabilities.

Moreover, a cellular phone according to the present invention is equipped with an RFID tag/chip, providing active or passive communication. As is known to a person skilled in the present art, current devices with cellular phone transmission capabilities are equipped with IR and/or Bluetooth communication to transmit and receive data. Hence, it is appreciated that the encryption protocol/scheme is downloaded to the cellular device according to the present invention and stored in one of the devices available memories.

When the expression cellular phone is used throughout the description of the present invention it should be regarded as a pocket sized handheld device having cellular phone capabilities which also includes a PDA (Personal Digital Assistant) operating in any cellular network or the like such as GSM (Global System for Mobile communication) utilizing TDMA (Time Division Multiple Access), CDMA (Code Division Multiple Access), WCDMA (Wideband Code Division Multiple Access, FDMA (Frequency Division Multiple Access) or any other in the market appropriate mobile or cellular system.

Throughout the present description of the provided invention, the presented embodiments and given examples should be understood to incorporate the hereinafter described inventive encryption protocol/scheme. The encryption thus incorporates the well known cryptography/encryption algorithms named Blowfish, TwoFish, RSA (Rivest-Shamir-Adleman), Ghost and the like. Blowfish is a keyed symmetric block cipher designed by Bruce Schneier, and the Diffie-Hellman key agreement/key exchange protocol, RSA, Ghost and the like, which allow two users to exchange a secret key over an insecure medium without any prior secrets. Diffie-Hellman creates keys from predetermined keys in the devices of the present invention. RSA and Ghost can be utilized both as encryption algorithms and key encryption protocols. All the mentioned encryption algorithms and key encryption protocols are well known to a person skilled in the art.

It is appreciated, although utilizing known algorithms and protocols, they are modified in accordance with inventive features to its utilization, and that Blowfish and Diffie-Hellman are utilized to exemplify the embodiments oft the present invention, without necessarily limiting the invention to those.

When the expression POS is mentioned it comprises any point of sale for instance such as found in shops, malls, and ticket machines at bus stations, subway stations, train stations, Airports, parking lots and the likes. It is also appreciated that a call and/or data in the context of the present invention includes speech and/or data transmission by establishing a data connection. An entrance passing and electronic purchasing through Internet can also be introduced through the POS features described through the present invention.

Hence, the present invention provides a system comprising a first radio operated device such as a cellular phone, and a second radio operated device, could also be a cellular phone, or a device as depicted in FIG. 4, adapted to at least one of receiving and transmitting encrypted data between each other. Both the first and the second device comprise in one embodiment of the invention a 448 bit Blowfish encryption algorithm in an electronic memory of the devices as well as a Diffie-Hellman key agreement protocol, 512/1024 bits, to provide a final key which activates the Blowfish encryption in the devices. This key is transmitted from the device starting a transmission to a receiving device, which agrees to the key through a hand-shaking procedure. When the hand-shaking is successful, the key triggers the Blowfish algorithm to start encrypting data to be transmitted, and the Blowfish algorithm on the receiving side of the transmission is triggered to encode the received data as the both Blowfish algorithms are utilizing the same agreed key transmitted through the Diffie-Hellman protocol.

The key that is agreed upon through the hand-shaking is in one embodiment created as follows, by the Diffie-Hellman protocol is given a random multiple 16 bit integer start value. This integer start value is continuously incremented through a dedicated software loop for that purpose. Hence, the continuously incremented integer is provided as a random start value, as a first 16 bit key, received by the Diffie-Hellman protocol at the moment of a transmission being established by one of the devices.

Another value input to the Diffie-Hellman is a device user key entered and changeable by the user through for instance a menu on a cellular phone display, hereby named the second key. Still further the Diffie-Hellman protocol is provided a third key fixed and hard coded in the devices, as well as the 512 bit hard coded prime number. This third key identifies the card (Visa, MasterCard, American Express or the like cards) or a specific predetermined company, organization by a number for instance a card number or organization No.

The Diffie-hellman protocol utilizing the first, second and third key and the hard coded prime number to create a final common key to be utilized by the devices communicating to trigger the Blowfish encryption and/or encoding. Hence, after agreement through hand shaking of the final key, provided by the Diffie-Hellman protocol, by the first and second devices through a radio communication, the blowfish algorithm starts encrypting an established transmission of data between the first and at least one second device through a so called tunnel described below.

Transmitted data is packet as a header of a predetermined number of bytes such as for instance a 1 byte header plus encrypted data of a predetermined number of bytes such as for instance 24 bytes. The header is utilized to synchronize transmission of data if bytes in a communication between devices are lost or added during transmission. To be able to minimize delay time between devices participating in a transmission of data, incoming data traffic to a device is searched for the latest header, and earlier received data is discarded, whereby the encrypted data always comprises the latest complete incoming header plus data, which is stored in a buffer of a predetermined size for instance of four packets of header plus data. This makes up the so called tunnel for transmission as mentioned above.

An established transmission is released if the text CARRIER is a part of incoming data, or when a button for releasing transmission is pushed on the first or second devices such a button could for instance be the hang up button on a cellular phone or the hands free button.

Now summarizing the encryption and key exchange in steps:

1. Establish a data communication between device A to B

2. Check initializing keys. If OK, then proceed to step 3.

3. Device A generates one new key and transmits it to device B.

4. Connection established if the key is recognized by device B.

5. Encryption is on.

In accordance with one embodiment, the first device has cellular phone capacity and the at least one second device also has cellular phone capacity. Alternatively, the first device has cellular phone capacity, and the second device is an entity, se FIG. 4, connected/comprised to/in a POS terminal, whereby a purchase is accomplished through the phone and the entity, utilizing RFID or Bluetooth transmission. Hence, the cellular phone and the second device are provided RFID tags/chips between which a transmission of data is established. Communication between the first and second device can also be established through Bluetooth.

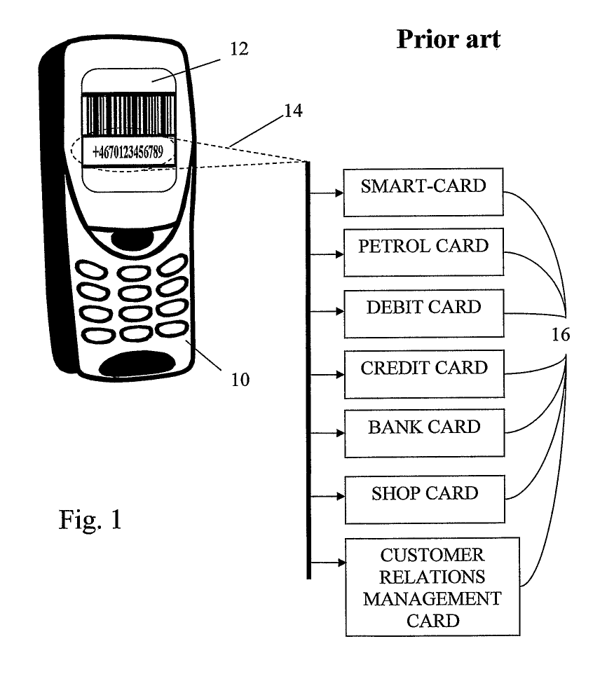

FIG. 1 schematically illustrates one prior art embodiment of a cellular phone 10 in accordance with the present invention. The phone 10 has a unique subscriber telephone number attached to it, herein fictively +4670123456789, identifying the person and/or company having the subscription. Depicted in FIG. 1 is a tag 12, which can be of any type such as a barcode, RFID tag (those are not shown), but they are comprising the telephone number to the cellular phone 10 as shown at reference numeral 14. The tag 12 is intended to be scanned/read at a point of sale for connecting the telephone number to a purchase. If not a tag 12 is utilized, a point of sale (POS) terminal comprising a keypad could be utilized to enter the telephone number, +4670123456789, and the PIN code, or a tag or barcode, 2D code or the like could be stored in the cellular phone 10 memory and be re-called to be displayed on the phone 10 screen (not shown). An alternative is to phone the POS with, +4670123456789, to store and connect the phone number to a purchase. This requires that the POS is equipped with a telephone call receiver for this purpose.

The PIN code in one embodiment is of the biometric type such as a fingerprint being transmitted to the phone 10 by radiation to a receiver at the POS, or by being displayed on the phones screen and scanned at the POS.

As the telephone number, +4670123456789, is an unique identifier of a person subscribing to it for instance connecting the address of the person through the subscription it can be utilized to connect all the bank data held by that person together with a personal identity code (PIN code). A person's bank data is schematically illustrated as a set of cards 16 such as smart card, petrol card, debit card, credit card bank card, shop card and other like cards. Hence, the persons/companies bank data for authorization of payment transfer according to the data, for instance comprised on the cards 16 is stored in a database at a bank server under the database post +4670123456789 in one embodiment of the present invention such as:

Post: +4670123456789
Bank(-ing) authorization data
PIN code

An idea comprises that a cellular telephone 10 number, +4670123456789, is a unique identifier of the person/company bearing the phone 10. Thus, by calling a predetermined number leading to an acquirer node application (acquire node), and storing the cellular number in an acquirer database at a point of sale, and simultaneously entering the same number at the point of sale, whereby the number called in and the one entered are matched at the acquirer it is secured that the phone owner is identified and granted to make a purchase. This is described more in detail with reference to FIG. 3. The acquire node application acts as a communication device and holds software for accomplishing telephone A-number identification/retrieving it, checking phone numbers, equipment for receiving telephone calls, and other necessary tasks known to a person skilled in the art for acting as an acquirer.

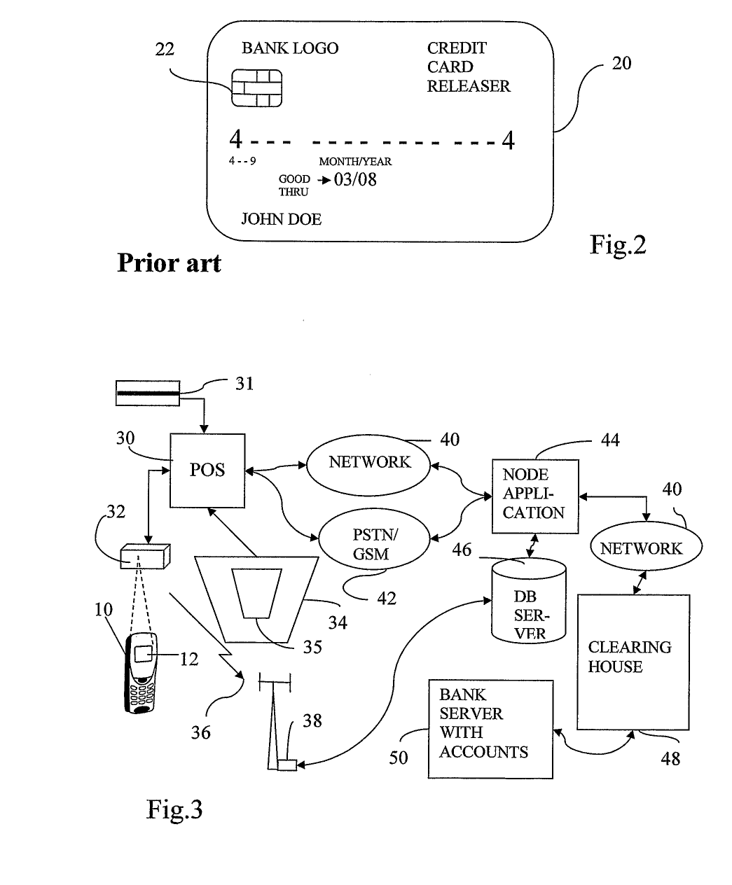

In FIG. 2, schematically illustrated, is one embodiment of a bank card 20 in accordance with the present invention and its identity/authorization data.

The ANSI Standard X4.13-1983 is utilized by many credit card systems. Here are what some of the numbers on the card stand for.

The first digit in on a credit-card number signifies the system, 3—travel/entertainment cards (such as American Express and Diners Club), 4—Visa, 5—MasterCard, 6—Discover Card. The structure of the card number, 4 --- ---- ---- --- 4, as depicted in FIG. 2 on card 20 varies by system. For example, American Express card numbers start with 37; Carte Blanche and Diners Club with 38. American Express—digits three and four are type and currency, digits five through 11 are the account number, digits 12 through 14 are the card number within the account and digit 15 is a check digit. The Visa—digits two through six are the bank number, digits seven through 12 or seven through 15 are the account number and digit 13 or 16 is a check digit. MasterCard—digits two and three, two through four, two through five or two through six are the bank number (depending on whether digit two is a 1, 2, 3 or other). The digits after the bank number up through digit 15 are the account number, and digit 16 is a check digit, here a 4.

The stripe on the back of a credit card is a magnetic stripe, often called a magstripe. There are three tracks on the magstripe. Each track is about one-tenth of an inch wide. The ISO/IEC standard 7811, which is used by banks, specifies that track one is 210 bits per inch (bpi), and holds 79 6-bit plus parity bit read-only characters. The track two is 75 bpi, and holds 40 4-bit plus parity bit characters. Track three is 210 bpi, and holds 107 4-bit plus parity bit characters. A credit card 20 typically uses only tracks one and two. Track three is a read/write track (which includes an encrypted PIN, country code, currency units and amount authorized), but its usage is not standardized among banks.

The information on track one is contained in two formats: A, which is reserved for proprietary use of the card issuer, and B, which includes the following: Start sentinel—one character, format code=“B”—one character (alpha only), primary account number—up to 19 characters, separator—one character, country code—three characters, name—two to 26 characters, separator—one character, expiration date or separator—four characters or one character, discretionary data—enough characters to fill out maximum record length (79 characters total), end sentinel—one character, and longitudinal redundancy check (LRC)—one character. LRC is a form of computed check character.

The format for track two, developed by the banking industry, is as follows: Start sentinel—one character, primary account number—up to 19 characters, separator—one character, country code—three characters, expiration date or separator—four characters or one character, discretionary data—enough characters to fill out maximum record length (40 characters total), and LRC—one character.

Information on the track format, see ISO Magnetic Stripe Card Standards.

There are three basic methods for determining (authentication) whether the credit card will pay for what is charged: Merchants with few transactions each month do voice authentication using a touch-tone phone, electronic data capture (EDC) magstripe-card swipe terminals are becoming more common—so is swiping the card at the checkout, virtual terminals on the Internet.

After for instance the cashier or the person purchasing swipes the credit card 20 through a reader, the EDC software at the point-of-sale (POS), see FIG. 3, showing partially prior art, terminal dials a stored telephone number, utilizing a modem, broadband connection, wireless or other network and equipment known to a person skilled in the art, to call an acquirer. An acquirer is an organization that collects credit-authentication requests from merchants and provides the merchants with a payment guarantee. When an acquirer company receives the credit-card authentication request, it checks the transaction for validity and the record on the magstripe for: Merchant ID, valid card number, expiration date, credit-card limit, card usage.

The “smart” credit card (smart card) is an innovative application that involves all aspects of cryptography (secret codes), not just the authentication described. A smart card 20 has a microprocessor 22 built into the card itself. Cryptography is essential to the functioning of these cards. A user must corroborate his identity to the card each time a transaction is made, in much the same way that a PIN is used with an ATM (Automated Teller Machine). The card and the card reader executes a sequence of encrypted sign/countersign-like exchanges to verify that each is dealing with a legitimate counterpart. Once this has been established, the transaction itself is carried out in encrypted form to prevent anyone, including the cardholder or the merchant whose card reader is involved, from “eavesdropping” on the exchange and later impersonating either party to defraud the system. This elaborate protocol is conducted in such a way that it is invisible to the user, except for the necessity of entering a PIN to begin the transaction.

The chip in these cards are capable of many kinds of transactions. For example, make purchases from a card holder's credit account, debit account or from a stored account value that is reload-able. The enhanced memory and processing capacity of the smart card is many times that of traditional magnetic-stripe cards and can accommodate several different applications on a single card. It can also hold identification information, keep track of participation in an affinity (loyalty) program or provide access to premises.

The information described above held by a bank card 20, or smart card 20, 22 is similar to that what is expected to be stored under the database post or telephone number, +4670123456789, as bank data/authorization data together with a PIN code, or regarding a smart card 20, 22, this information/data is stored also in a memory, for instance SIM card or internal phone memory, of the cellular phone 10 to be transmitted from a POS to the database holding the post, +4670123456789, for comparison of correctness.

In one preferred embodiment encryption/encoding software is bound/affiliated to a cellular phones international mobile station equipment identity (IMEI), which is a wireless telecommunication term utilized to identify every specific cellular phone or mobile station.

Moreover the present invention introduces a further security or authorization feature by calling the database, through its telephone number here fictively 9876543210, holding the database post with telephone numbers by the phone 10, with telephone number, +4670123456789, similar to making a card purchase at the POS. It is thus checked that the scanned or otherwise transmitted telephone number at the POS is +4670123456789, the same that has called the database, and if so a purchase is granted and the acquirer node sends a signal to the POS that the purchase is granted. This is described through the system of FIG. 3 depicting one embodiment out of several possible following the teaching related to the present invention.

FIG. 3 schematically illustrates an embodiment of a system for a POS 30 in accordance with the present invention, herein including a clearing house which is common. The POS 30 system is equipped with a device/puck/pay module 32 (not being prior art) in accordance with the present invention comprising a scanner 73 and a terminal 34 for entering PIN codes and other characters through a keypad 35. It can also be equipped and connected to a swipe card slot 31 in one embodiment of the present invention A customer purchasing at the POS holds his cellular phone 10, with tag 12, to be scanned by the scanner 73 comprised in the device 32, depicted in FIG. 4, or utilizing one of the methods described above to connect the telephone number, +46701234567890, to the purchase, almost simultaneously, the purchaser calls 36, schematically indicated by a GSM base station 38, with the phone 10 bearing the number, +4670123456789, a database server 46, utilizing a predetermined telephone number, her fictively 9876543210, at an acquirer node application 44, where the database server 46 stores the database posts holding telephone numbers that are connected and authorized to make purchases, as for instance +4670123456789 pointing at bank data allowing a purchase of merchandizes, goods, services and the like. The call is registered with the telephone number, +4670123456789, in the database 46. The call can be stored for a limited time, for example, two to five minutes, so that another purchase in a different store is possible. The POS 30 connects to the acquirer node application through one of the networks 40, 42. The connection to the acquirer node 44 could be established by the POS 30 attendant swiping a special card for the store or POS 30 in question opening up the communication for a purchase as it is actually currently accomplished when purchasing by using a bank card, thus emulating a connection as if the purchase was accomplished through a card.

If the phone 10 has stored bank data emulating a smart card, the data has been transmitted for instance when calling the acquirer having telephone number 9876543210.

At the acquirer node 44 it is checked through dedicated software for that purpose that the phone number +4670123456789 from the POS is the same as the one stored when the phone 10 was brought to call 9876543210 to register the phone number +4670123456789 for a purchase, and if so the database is checked that phone 10 holding number +4670123456789 is a registered telephone number allowed to be used for purchases. The PIN code is checked together with bank authorization data. If the purchase is granted by the acquirer a grant message/signal is sent to the POS 30 and the purchase is closed as being correct and granted.

This purchase is accomplished more or less as a current purchase with a bank card 20, 22, and very little upgrading of equipment has to be deployed at the POS 30 in order to make a purchase. If the POS 30 utilizes the feature of receiving a call from the phone 10 to connect the purchase with a phone number, +4670123456789, as described above, equipment such as receivers for that purpose are to be installed.

It is appreciated that it is known to a person skilled in the art how to detect the phone number, +4670123456789, by A-number identification and CallerID. It is also recognized that the telephone numbers used in the present description are fictive, and that an almost unlimited number of phones can be registered in databases 46 as database post for utilizing the findings of the present invention.

In order to settle the accounts between the purchaser and the POS 30 merchant, the acquirer 44 connects through a network 40 a clearing house 48, which settles the accounts by debiting the purchaser account at his/her bank and crediting the merchant at his/her bank through their bank server 50.

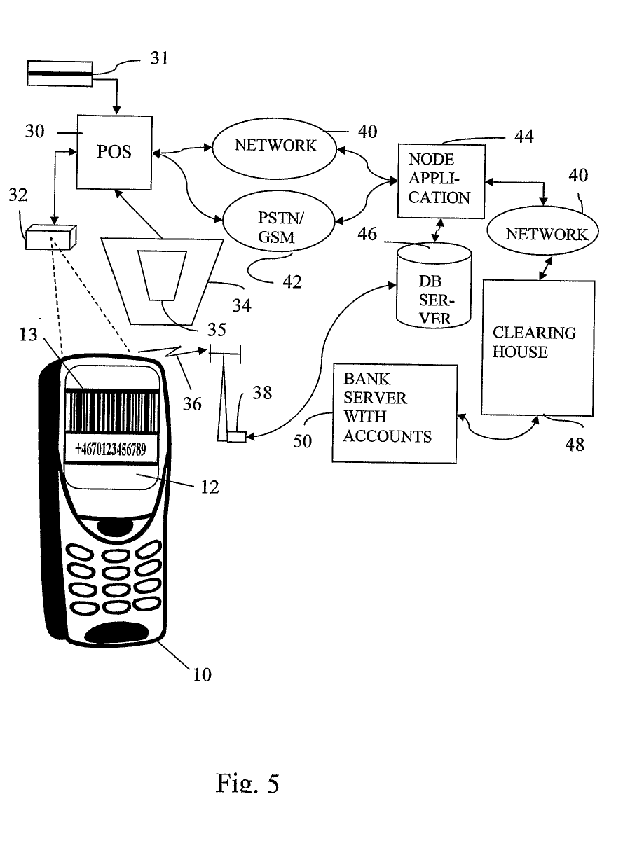

FIG. 4 schematically illustrates a block diagram of a device/puck/pay module 32 connected to a POS depicted in FIG. 3 and FIG. 5 in accordance with the present invention. The device 32 comprises a micro controller unit 60, which controls the device 42 tasks. A flash memory 62 is used to store the source code needed to operate the device 32. Moreover, the device 32 comprises at least one of an Rs232, Rs485 interface and a universal bus interface (USB) for connection to external devices such as a POS 30, having ports for such connection. It communicates through at least one of a Bluetooth receiver and/or transmitter 68 and a RFID receiver and/or transmitter 70. An RFID 70 can be of a passive or active type.

The device 32 also comprises a switch 74, for example, a dip switch, which provides easy access to different software for external communication with for instance POS terminals stored in the flash memory 62.

Any purchase through a POS 30 in accordance with the present invention utilizes the same protocols as currently used for backbone communication, i.e., communication utilized beyond the device 32 of the present invention to verify so called card data by for instance utilization of the PCI-DSS standard. Hence, no modification to existing POS is normally necessary if the POS has interfaces adapted to receive communication through USB, Rs232, and Rs485 ports, or other similar known communication ports.

Hence, the radio operated device 32, the second device in the attached claims 1 to 6, is adapted to at least one of receiving and transmitting encrypted data, from and/or to a cellular phone 10, 11 comprising an RFID tag or chip and/or a Bluetooth chip. Encryption and/or encoding is accomplished and supported by having technology for Blowfish and Diffie-Hellman stored in the flash memory 64, operated in accordance with the inventive method described above. The RFID chip in the cellular phone 10, 11 can be of the strip type, as a chip attached in the cellular phone or as a chip integrated in the cellular phone SIM card (Subscriber Identity Module).

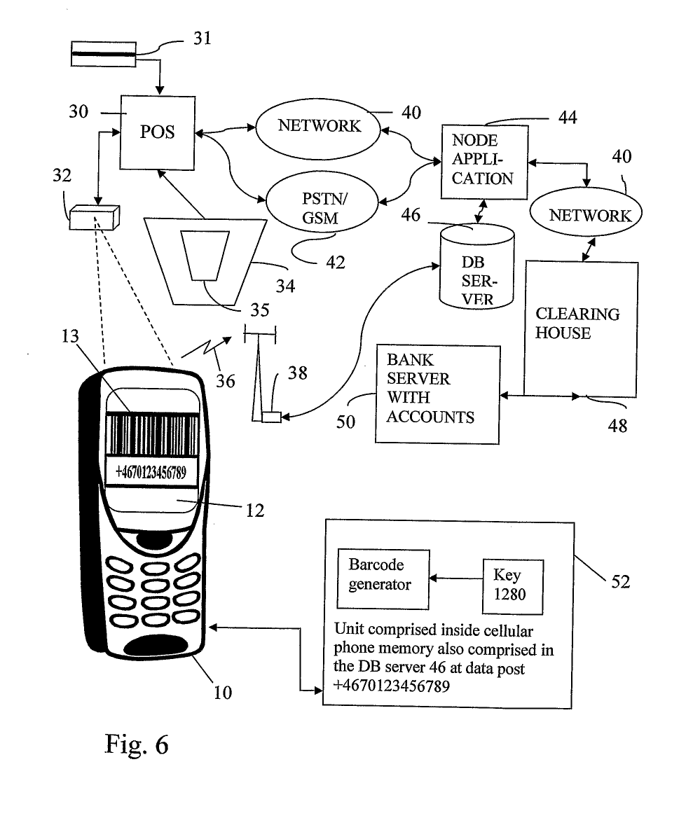

In one alternative embodiment depicted through FIG. 6, the device 32 comprises a bar code and/or 2D code generator generating a new code every time a purchase at a POS 30 is accomplished, which is transmitted to the cellular phone 10, 11 to be displayed and scanned by a code scanner connected to or comprised in the device 32 at the next purchase as depicted in FIG. 6. A purchase made through a cellular phone 10, 11 can be confirmed by entering a PIN code at the POS 30 through a key pad 34 as is made currently when purchasing or registering with cards 16.

In another embodiment, the device 32 is equipped with cellular radio capabilities such as GSM, GSM/3G or the like. If the device 32 is equipped with a PCMCIA slot and card 76 such cellular radio communication can be provided through the PCMCIA card 76, or alternatively with a USB device providing radio communication (not shown). Cellular communication can also be provided by integrating it to the device 32 (not shown).

FIGS. 5 and 6 schematically illustrating a system according to FIG. 3, wherein a cellular phone 10 and a database 46 comprises the same unit/program 52 generating barcodes 13 or 2D codes or like codes known to a person skilled in the art. An embodiment of the present invention thus provides that a cellular phone 10 comprises a barcode generator generating barcodes 13 in the phone display 12 with the use of encryption keys provided to a database 46 and the phone memory unit 52, comprising the same barcode generator and encryption key in a data post bearing the phone number, +4670123456789 or referring to it, of the cellular phone 10 mentioned. Hence, the same barcode 13 is generated in booth the cellular phone 10 and the database 46 (indicated by a broken line connector in FIG. 4 at any predetermined given time period for matching when purchasing at a POS 30 equipped with a card slot swipe 31, through the barcode 13 presented in the cellular phone display 12, thus preventing forgery by for example by taking a footage of the barcode 13, only being valid at one POS purchase, presented in the display 12 together with the specific phone number for the phone, also stored in the database for matching as described above. In one embodiment the phone number, +4670123456789, is always present within the barcode 13, but the barcode 13 is differently generated for every purchase at a POS 30 or the like by the utilization of a key for instance 1280 as depicted in FIG. 6, as mentioned, or other known encryption technique known to a person skilled in the art.

In another embodiment the key could be generated by the encryption program in the database when registering the cellular phone 10 number, +4670123456789 in accordance with the present invention and sent to the phone 10 memory unit 52, which produces the same barcode 13 as the database for a matching as described above through the key.

In a further embodiment the key can be entered in the database at any given time, i.e., allowing changes of the key, as well as it is registered in the phone memory unit 52 in order to let the memory unit 52 and database 46 produce the same barcode 13.

The cellular phone 10 memory unit 52 can reside in the phone SIM card or in an internal phone 10 memory.

As mentioned the barcode 13 can be simultaneously generated in the phone bar code generator software and the database 46, thus matching each other to enable a purchase. This generating of a barcode could be synchronized to occur at every purchase or at a predetermined time, determined by for instance a timer, not shown, to further inhibit forgery of the barcode 13 as the time for generation of a barcode can be arbitrary accomplished.

In one embodiment, the barcode generator and/or key can be transmitted to the phone memory unit 52 when registering the phone number, +04670123456789, for purchase at a POS as described above.

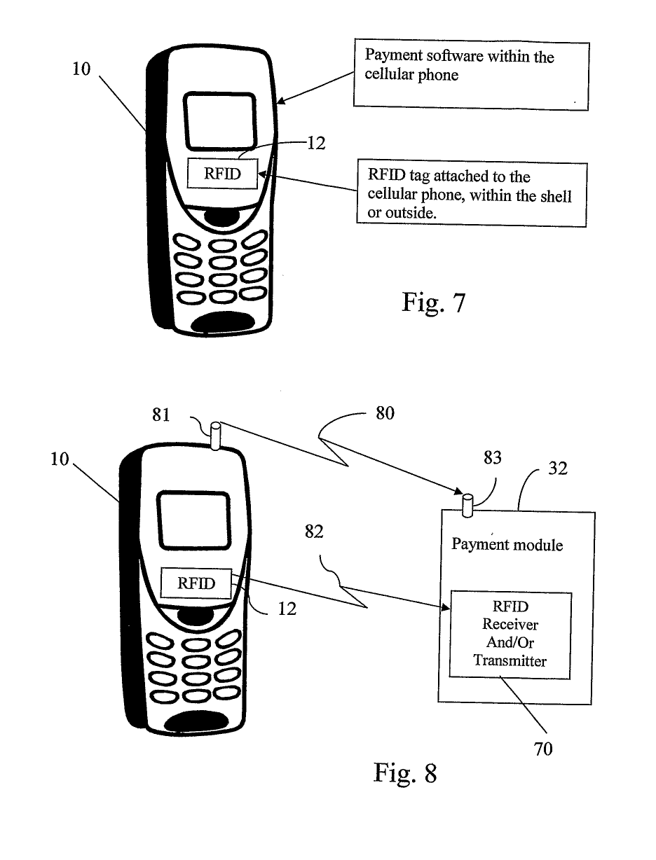

FIG. 7 depicts a cellular phone 10, having an RFID tag 12 attached to it within the shell of the phone 10 our on its outer body. The phone 10 has software stored in one of its memories (not shown), which software is utilized to perform purchases according to the present invention as described. The RFID tag 12 is active in this embodiment and programmable. This embodiment of a phone 10 will illustrate through successive FIGS. 8-10 how it is prevented to be able to clone the software residing in the phones memories utilized to accomplish payment according to the present invention.

Every tag 12 has a unique identifier such as a number or the like attached to it identifying the tag 12, as well as the software has a unique identification according to the present invention.

Hereby, FIG. 8 illustrates when a cellular phone 10 approaches the pay module 32. The phone 10 contacts the module 32 through its blue tooth capabilities transmitting the unique payment software identification number, schematically symbolized through the phone 10 antenna 81 and the signaling 80 received by the module 32 through the antenna 83. Eventually, the phone 10 will be that close to the module 32, and the RFID tag 12 transmits its unique identification to the module 32 and the RFID receiver/transmitter 70, schematically illustrated by the signaling 82.

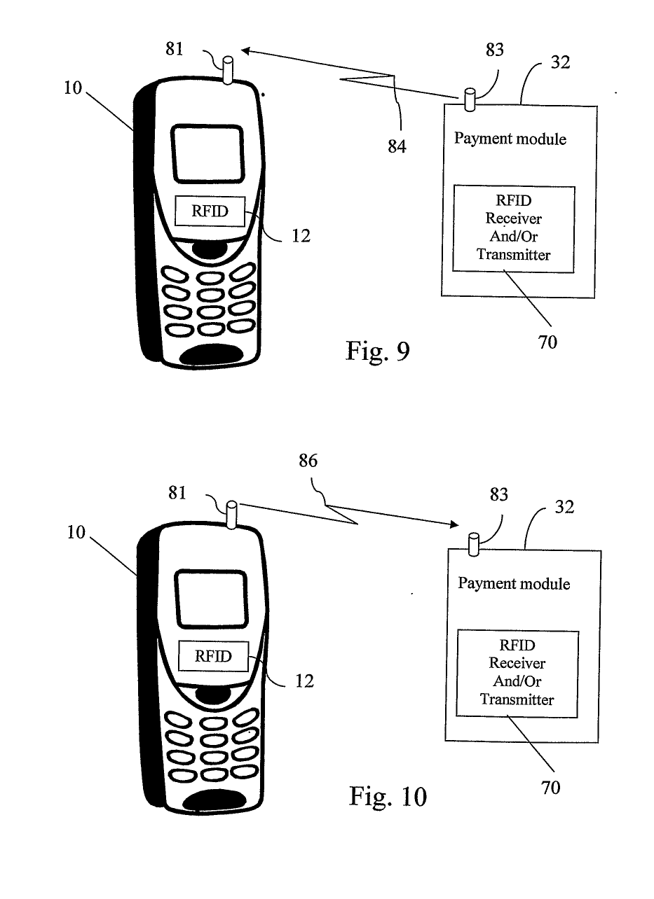

Now, with reference to FIG. 9, the module through software compares that the unique tag 12 identifier is uniquely/solely connected to the unique software identifier and vice versa. If this is the case, the module 32 acknowledges, schematically illustrated through blue tooth signaling 84 to the payment software, that the payment software and the tag identifier are mutually compatible or belongs together. According to the present invention solely one tag is valid to be connected to one payment software residing in the phone 10. Hence, if a payment software is cloned and utilized in another phone 10 a communication to the module 32 will fail as the correct tag 12 identifier is missing, and a comparison in the module 32 will be negative.

FIG. 10 depicts that the payment software matches the tag identification, schematically illustrated by the blue tooth acknowledgement signaling 86 to the module 32, and a payment transaction can be established or is established.

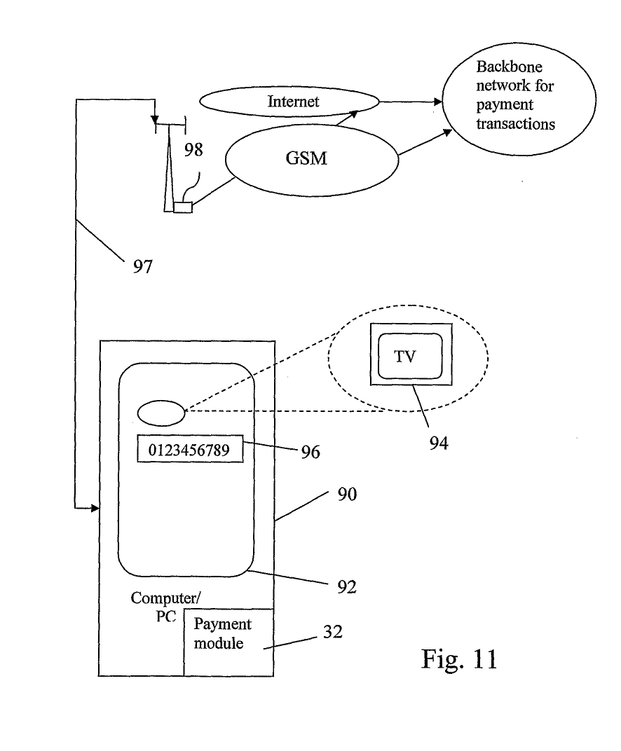

In FIG. 11 another embodiment of the utilization of the payment module 32 is schematically depicted. A purchaser utilizes the cellular phone/PC 90 with a display screen 92 to by goods 94 from a provider of goods (not shown) via Internet. As an example a TV is depicted as goods to be purchased. In a field 96 connected to the goods 94, the user enters the telephone number, herein fictive as 0123456789, of the phone 90 or another cellular phone number when utilizing a PC for the purchase (hot shown), and transmits 97 the indicated purchase of a TV to the provider, herein for instance via GSM/3G.

Now, the provider transmits 97 for instance an SMS/MSM to the telephone 90 comprising a code/password to be entered in a field on the phone screen 92 utilized to finish the purchase (not shown). When it is entered, the user transmits 97 the password to the provider, which closes the purchase. Alternatively, a personal PIN code known by the user could be entered in another field (not shown), further safeguarding the purchase.

The payment module 32 transfers the cash payable for the TV set as described according to embodiments described above through a schematically depicted backbone net for payment transactions as known to a person skilled in the art. It is appreciated that in one embodiment of the payment module 32 according to FIG. 11 encryption/encoding software is bound/affiliated to a cellular phones 10/computer/PC 90. Furthermore, the invention according to FIG. 11 can be utilized for entrance passing, thus instead of purchasing goods an entrance provider receives the telephone number, 0123456789, and returns an SMS/MMS or the like with a password, and the user proceeds in accordance with what is described in regard of FIG. 11.

Such an entrance good be a closed door, a ticket gate at subways, train stations, and almost every where an entrance password is required.

Also, the present invention is not restricted to telephone numbers as codes. Other suitable codes could be utilized to recognize RFID and blue tooth identification.

The present invention is not limited to given examples and embodiments, but to what a person skilled in the art can derive from the attached set of claims.

1-6. (canceled)

7. A system comprising:
a first radio operated device; and
at least one second radio operated device adapted to at least one of receiving and transmitting encrypted data between each other by establishing a data connection comprising:
radio frequency identification means; and
blue tooth capacity, said first device having payment software comprising a unique identification, said first device radio frequency identification having a unique identification attached to it, said first device unique identifications being transmitted to said second device and matched in said second device to detect if they are valid for said first device, only one first device having a radio frequency identification tag that is recognized by said payment software and vice versa, thus preventing the payment software being utilized as a clone in other first devices, said first and at least one second device comprise:
an encryption algorithm in a memory;
a key exchange protocol to provide a final key which activates said encryption algorithm to encrypt in said devices;
a random multiple integer start value generator, continuously incrementing said integer in a loop for such a purpose; said continuously incremented integer being a random start value received by said key exchange protocol at the moment of a transmission being established by one of said devices utilized by said key exchange as a first key;
a changeable device user second key, input by said user to said key exchange protocol; and
a third key being hard coded and provided said key exchange protocol, said key exchange protocol utilizing said first, second and third key to create said final key to start said encryption algorithm, after agreement through hand shaking of said final key, provided by said key exchange protocol, by said first and second devices through a radio communication, said encryption algorithm starts encrypting an established transmission of data between said first and at least one second device, transmitted data is packet as a header of a predetermined number of bytes plus encrypted data of a predetermined number of bytes, said header being utilized to synchronize transmission of data if bytes in a communication between devices are lost or added, and, to minimize delay time between devices participating in a transmission of data, incoming data traffic is searched for the latest header, and earlier received data is discarded, whereby the encrypted data always comprises the latest complete incoming header plus data.

8. A system according to claim 7, wherein an established transmission is released if the text CARRIER is a part of incoming data, or when a button for releasing transmission is pushed on said first or second devices.

9. A system according to claim 7, wherein said first device has cellular phone capacity and said at least one second device has cellular phone capacity.

10. A system according to claim 7, wherein said first device has cellular phone capacity, and said second device is an entity connected/comprised to/in a post of sale terminal, whereby a purchase is accomplished through said phone and said second device, utilizing RFID and/or Bluetooth transmission.

11. A system according to claim 7, wherein communication between said first and second device is initially established through Bluetooth, and later by radio frequency identification means.

12. A system according to claim 9, wherein encryption/encoding software is bound/affiliated to a cellular phones international mobile station equipment identity.
